(19) United States
(12) Patent Application Publication
(10) Pub. No.: US 2011/0090258 A1
(43) Pub. Date: Apr. 21, 2011

(54) DEVICE AND METHOD FOR ANIMATING A GRAPHIC DIGITAL DOCUMENT

(75) Inventor: Alex Racic, Pullach (DE)

(73) Assignee: BOOKRIX GMBH & CO. KG, Munich (DE)

(21) Appl. No.: 12/867,027

(22) PCT Filed: Feb. 6, 2009
(86) PCT No.: PCT/EP2009/051411

§ 371 Date: Dec. 3, 2010

(30) Foreign Application Priority Data
Feb. 11, 2008 (DE) 102008008730.0-53

(51) Int. Cl. G06T 3/40

(52) U.S. Cl. 345/660

(57) ABSTRACT

The invention relates to a device for the automated animation of a sequence of computer graphics that form pages of a digital document, the memory for said device having a layout data set with opposing layout regions and foreground and background planes, to which computer graphics are assigned in a specific manner and the processing unit for said device being designed to reduce the display width of the second computer graphic in stages to provide the layout data set for the display, to assign the first computer graphic to the background plane of the first layout region, to assign a display width of approximately zero to the first computer graphic that is assigned to the foreground plane of the first layout region and to increase the display width of the third computer graphic in stages to provide the layout data set for the display. The invention also relates to an associated method, to a device and method for providing the layout data set for the display, to an assembly, a computer programme product and a data structure product for said animation.

### TECHNICAL FIELD

The invention relates to an apparatus for the automated animation of a sequence of computer graphics which form pages of a digital document, having a processing unit and a memory, and also to a method, an apparatus and a method for providing a layout data record, and to an arrangement, a computer program product and a data structure product therefor.

### BACKGROUND TO THE INVENTION

For the purpose of viewing digital documents (electronic documents) such as E-books, the prior art discloses display devices and methods which are intended to facilitate reading of the electronic document. In this context, it is particularly desirable to condition and present the document contents automatically such that they are convenient for the viewer to absorb and approximate the presentation of the familiar manner of presentation, for example in a bound book.

The German translation DE 695 21 575 T2 of the European patent specification EP 0 701 220 B1 discloses a method for the presentation of an electronic document which allows reading of the digital document to involve, regardless of the actual document layout, a content flow being followed, the order of which has been explicitly defined by combinations of the paragraphs or sections contained in the document. This allows the central theme of a content relationship to be presented coherently by the display device, even if the content flow of an article extends over more than one page.

In this case, it may become necessary not just to scroll over one page but also to change between the pages, which gives rise to a certain resource requirement particularly if the pages to be presented are formed by computer graphics (textural graphics) and are not encoded.

To present such changing in a pleasing manner, the German laid-open specification DE 102 07 115 A1 discloses an apparatus for electronically turning pages of a digital document which provides the user with haptic interaction by means of a special operator control unit and with the visual impression of conventional (paper) printed products having their pages turned on the monitor. In this context, the handling of the operator control unit directly controls the graphically presented animation of page-turning on the basis of direction and speed of movement. To enhance the visual impression further, it is proposed that the individual digital pages be presented as a succession of single pages situated above one another.

In the case of this solution, however, there is typically a great need for storage and computation capacity, since a large number of digital book pages need to be kept available for rapid access and said pages each need to be quickly converted into appropriate graphical representations of the page-turning movement dynamically on the basis of the user inputs. In addition, the need for rapid accessibility means that the digital document needs to be available largely completely in the display unit and hence, if the digital document is provided by a network, communication resources are demanded to an increased extent.

It is therefore an object of the present invention to specify an apparatus and a method which automatically animate a sequence of computer graphics which form pages of a digital document such that the visual effect of page-turning is produced, and in this context the resource efficiency is improved by virtue of the need for memory and communication resources being reduced in comparison with the solutions known from the prior art, and also an apparatus and a method for providing a layout data record, an arrangement, a computer program product and a data structure product therefor.

### OVERVIEW OF THE INVENTION

The invention achieves this object by means of the subject matter of claims 1, 16, 25, 34, 40, 41, 42 and 43.

The invention according to claim 1 teaches an apparatus for the automated animation of a sequence of computer graphics which form pages of a digital document, having a processing unit and a memory, characterized in that
the memory has a layout data record, and the layout data record contains a first layout area having a background plane and a foreground plane and contains a second layout area, which is opposite the first layout area, having a first background plane and a foreground plane;
the layout data record has an associated first, second, third and fourth computer graphic, wherein the first and second computer graphics form the open rectos of a double-sided digital document, and wherein the third and fourth computer graphics form the open rectos of the document after forward page-turning;
the first computer graphic is associated with the foreground plane of the first layout area, the second computer graphic is associated with the foreground plane of the second layout area, the third computer graphic is associated with the foreground plane of the first layout area and the third computer graphic has an associated presentation width of approximately zero, and the fourth computer graphic is associated with the background plane of the second layout area;
the processing unit is designed to reduce the presentation width of the second computer graphic in steps while providing the layout data record for presentation;
the processing unit is designed to associate the first computer graphic with the background plane of the first layout area;
the processing unit is designed to associate a presentation width of approximately zero with the first computer graphic, which is associated with the foreground plane of the first layout area;
the processing unit is designed to increase the presentation width of the third computer graphic in the layout data record in steps while providing the layout data record for presentation.

The use of a layout data record provides a suitable, structured database in order to form the data basis for the automatic creation of the graphical animation of page-turning. This layout data record allows ease of management for the data contained therein and allows these data to be automatically assigned evaluable formatting properties during the computerized presentation.

The association of a selection of four computer graphics, which each form a page from a sequence of pages of a digital document, with said data record provides the page graphic data which are necessary for presenting a typical digital page-turning operation. Thus, the layout data record and the graphics associated therewith reduce the volume of data kept available so as to be simultaneously accessible for smoothly animated page-turning to a minimum, and hence significantly reduce the memory and communication requirement for presenting a double page and the animated page-turning to the subsequent double page.

The first and second computer graphics form the open rectos of a double-sided digital document, and the third and fourth computer graphics form the open rectos of the document after an animated forward page-turning operation. The layout data record with the graphics associated in accordance with the invention allows the double page comprising first and second graphics to be presented immediately, and the animated page-turning can be performed practically without delay.

Since the presentation time for a double page is typically longer than access to a layout data structure produced in accordance with the invention and the associated computer graphics, the presentation, the animated page-turning and the presentation of the pages open after the page-turning can be performed without delay and with only low demands on memory and data-provision or communication resources.

By virtue of the invention involving the modeling of two opposite layout areas with a background and a foreground plane in the layout data structure, and the invention involving the four computer graphics being associated with the planes of the background and foreground planes of the layout areas, for example through referencing of the graphics in appropriately attributed fields of the data record, it becomes possible to perform the animation process in a particularly resource-saving manner and in a manner which can be implemented with graphical presentation programs which are in widespread use in practice.

By virtue of the apparatus being designed to reduce the presentation width of the second computer graphic in the foreground plane in steps in the second layout area, so that the graphic is compressed as appropriate in the process, and at the same time the graphic which is initially concealed in the background plane appears in steps while retaining its full presentation width (that is to say without compression caused by animation), it becomes possible to animate the raising of the right-hand page of an open double page during the operation of forward page-turning.

By virtue of the processing unit also being designed to associate the first computer graphic in the first layout area with the background plane, so that now only the first graphic will appear during the presentation of the background, while the first graphic in the foreground area is provided with a presentation width of approximately zero, it becomes possible to prepare the operation of lowering the virtual page moved by the preceding raising.

This is achieved by the present invention in a particularly resource-efficient manner in that, instead of complex data copying operations, an association is merely altered, which association can be implemented by an appropriate reference, for example, and instead of frequently repeated allocation and release of memory space, the presentation width is merely altered, this once again merely requiring an appropriate association.

In any context of the substantive matter presented in this document, a presentation width of approximately zero means a presentation width which cannot or can almost no longer be perceived by a user who is looking at the presentation, such as any presentation width of less than ten, five, two pixels, or one pixel, particularly of zero pixels, or fewer than ten, five, two or one percent of the normal graphic width.

In embodiments in which the layout areas in the layout data record are modeled beside one another, so that a left-hand and a right-hand page are produced around a virtual vertical binding edge, the presentation width corresponds to the horizontal width of the graphic. In embodiments in which the layout areas in a layout data record are modeled above one another, so that an upper and a lower page are produced around a virtual horizontal binding edge, the presentation width corresponds to the vertical width (the vertical extent i.e. height) of the graphic.

Since the processing unit is designed to take the layout data record prepared in this manner as a basis for now increasing the presentation width of the third computer graphic in the foreground plane in a first layout area of approximately zero in steps, so that the compression of the graphic is reduced accordingly in the process, and at the same time the graphic which is initially presented in full in the background plane is concealed in steps while retaining its full presentation width (that is to say without compression caused by animation), it becomes possible to animate the lowering of the page.

The design of the apparatus to alter the presentation width in steps while providing the layout data record for presentation allows a presentation unit or a presentation component of the apparatus to access the layout data record and automatically evaluate it in order to produce an appropriate visual presentation on a screen.

The connection of a layout data record designed in this manner, which manages a small number of computer graphics required for the animation, to the present specifically designed animation functionality in a manner optimized for the animation steps provided by the apparatus not only allows a digital document to be provided for reading in a resource-saving manner, but also the visual effect of page-turning is produced without any significant additional technical resource complexity. By virtue of the animation operations taking place essentially firstly on the basis of associations between foreground and background areas, and secondly on the basis of changes in associated presentation widths in the layout data record, a particularly computational-efficient and memory-efficient method is provided which dispenses with application-specific memory operations and application-specific transformation of a mass of graphic data to the greatest possible extent.

The proposed solution allows implementation on widely used presentation devices, such as WWW browsers, without the burden of particular additional effort being placed on a user. Thus, a WWW browser calling an appropriate WWW page can be equipped with the layout data structure in the form of an HTML page together with associated graphics, and the browser can in the same way be set up with script programs which are suitable for performing the animation operation, such as JavaScript.

Further embodiments of the invention according to claim 1 can be realized in accordance with the subclaims which refer back to this claim.

By way of example, the invention may be developed further such that the processing unit is designed to alter the step size in the course of the step-by-step reduction in the presentation width of the second computer graphic. This allows the page-turning to be speeded up or slowed down, and the number of presentations used for the page-turning animation can be altered.

In particular, the processing unit may be designed to increase the step size as the presentation width of the second computer graphic decreases, for example.

Alternatively, or simultaneously the apparatus may be designed to alter the interval of time between two successive steps in the step-by-step reduction of the presentation width of the second computer graphic. This allows the page-turning animation to be speeded up without reducing the animation quality. Thus, the processing unit can be designed to reduce the interval of time as the presentation width decreases.

In embodiments of the invention, the layout data record may be in a form such that the computer graphics associated with the first layout area are oriented toward the second, layout area, and/or the computer graphics associated with the second layout area are oriented toward the first layout area. As a result, an orientation for the graphics in the visual presentation which follows from the layout data record is produced which corresponds to the arrangement of the pages which is to be expected for a double-sided document. In addition, the effect achieved by this is that the orientation continues to be ensured even if the presentation width is increased or decreased, so that broadening always occurs from the direction of the opposite page or the opposite layout area, and narrowing always occurs in the direction of the opposite page or the opposite layout area.

The layout data record may be in a form such that the first layout area and the second layout area form an interface.

Embodiments may be in a form such that
the layout data record has an associated fifth and sixth computer graphic, wherein the fifth and sixth computer graphics form the open rectos of the document after backward page-turning;
the fifth computer graphic is associated with the background plane of the first layout area, the sixth computer graphic is associated with the foreground plane of the second layout area and the sixth computer graphic has an associated presentation width of approximately zero;
the processing unit is designed to reduce the presentation width of the first computer graphic in steps while providing the layout data record for presentation;
the processing unit is designed to associate the second computer graphic with the background plane of the second layout area;
the processing unit is designed to associate a presentation width of approximately zero with the second computer graphic, which is associated with the foreground plane of the second layout area;
the processing unit is designed to increase the presentation width of the sixth computer graphic in steps while providing the layout data record for presentation.

This correspondingly allows backward page-turning to be animated too. As a result of the fifth and sixth graphics meaning that the pages which appear after backward page-turning are available in addition to the pages which appear after forward page-turning, it is possible, starting from a double page which needs to be presented, to animate forward or backward page-turning immediately without the need for additional data.

If the layout data record is produced at least to some extent using an SGML (Standard Generalized Markup Language), for example HTML (Hypertext Markup Language), then a markup language which is suitable in practice and which is supported by a large number of systems is used for realizing the layout data record.

In the case of HTML implementations, but also in the case of other layout definition formats, the layout data record may have a table element having at least one first and at least one second column, wherein the first column comprises the first layout area and the second column comprises the second layout area. Table elements are frequently available formatting elements and suitable for defining the layout area.

Accordingly for vertical page arrangements, the layout data record may have a table element having at least one first and at least one second row, wherein the first row comprises the first layout area and the second row comprises the second layout area.

In this case, the table element may be designed to reference at least one background graphic element and at least one foreground graphic element, wherein the background graphic element comprises the background plane and the foreground graphic element comprises the foreground plane. By creating a reference in the table element, it is possible to implement an association for a graphic with little complexity.

In embodiments, the processing unit may be designed to execute a script language program (e.g. JavaScript) in order to associate the presentation width and/or reduce and/or increase it in steps. This may involve alteration of format attributes stored in a layout data record.

The invention according to claim 16 provides a method for the automated animation of a sequence of computer graphics forming pages of a digital document, for an apparatus according to claim 1 or developments thereof, characterized in that

it has the following steps:
a layout data record is selected, wherein the layout data record is provided with a first layout area having a background plane and a foreground plane and a second layout area, which is opposite the first layout area, having a background plane and a foreground plane,
and wherein also the layout data record has an associated first, second, third and fourth computer graphic, wherein the first and second computer graphics form the open rectos of a double-sided digital document, and wherein the third and fourth computer graphics form the open rectos of the document after forward page-turning,
and wherein also the first computer graphic is associated with the foreground plane of the first layout area, the second computer graphic is associated with the foreground plane of the second layout area, the third computer graphic is associated with the foreground plane of the first layout area and the third computer graphic has an associated presentation width of approximately zero, and the fourth computer graphic is associated with the background plane of the second layout area;
the presentation width of the second computer graphic is reduced in steps;
the first computer graphic is associated with the background plane of the first layout area;
the presentation width of the first computer graphic, which is associated with the first layout area, is set to approximately zero;
the presentation width of the third computer graphic is increased in steps,

wherein the presentation width of the second computer graphic is reduced in steps and the presentation width of the third computer graphic is increased in steps while providing the layout data record for presentation.

This specifies a method for the operation of the apparatus according to claim 1 and the developments thereof which realizes the aforementioned advantageous effects by means of technical features which correspond to the apparatus.

Embodiments of the invention according to claim 16 can be realized in accordance with the subclaims which refer back to this claim and in accordance with the remaining developments and embodiments of all the apparatus and methods according to the invention.

The invention according to claim 25 teaches an apparatus for providing a layout data record for an apparatus as claimed in one of claims 1 to 15, having a processing unit and a memory, characterized in that
the processing unit is designed to select a first, second, third and fourth computer graphic, wherein the first and second computer graphics form the open rectos of a double-sided digital document, and wherein the third and fourth computer graphics form the open rectos of the document after forward page-turning;
the processing unit is designed to produce a layout data record in the memory and to provide the layout data record with a first layout area having a background plane and a foreground plane and with a second layout area, which is opposite the first layout area, having a background plane and a foreground plane;
the processing unit is designed to associate the first computer graphic with the foreground plane of the first layout area, to associate the second computer graphic with the foreground plane of the second layout area, to associate the third computer graphic with the foreground plane of the first layout area and to associate a presentation width of approximately zero with the third computer graphic, and to associate the fourth computer graphic with the background plane of the second layout area.

This provides an apparatus which produces the layout data structure and sets it up such that it can readily be used for the animation apparatus and the animation method. In this case, the apparatus for providing a layout data record may be integrated in an animation apparatus, wherein all the functionality may be combined in a common processing unit and a common memory, or the apparatus may be implemented as a server which is queried via a network by a client, which is formed by the animation apparatus.

Embodiments of the invention according to claim 25 can be realized in accordance with the subclaims which refer back to this claim, and in accordance with the remaining developments and embodiments of all the apparatuses and methods according to the invention.

The invention according to claim 34 teaches a method for an apparatus as claimed in claim 25 or developments thereof, for providing a layout data record, characterized in that it has the following steps:
a first, second, third and fourth computer graphic are selected, wherein the first and second computer graphics form the open rectos of a double-sided digital document, and wherein the third and fourth computer graphics form the open rectos of the document after forward page-turning;
a layout data record is produced in the memory, and a first layout area having a background plane and a foreground plane and a second layout area, which is opposite the first layout area, having a background plane and a foreground plane are provided in the layout data record;
the first computer graphic is associated with the foreground plane of the first layout area;
the second computer graphic is associated with the foreground plane of the second layout area;
the third computer graphic is associated with the foreground plane of the first layout area and the presentation width of the third computer graphic is set to approximately zero;
the fourth computer graphic is associated with the background plane of the second layout area.

This specifies a method for the operation of the apparatus according to claim 25 and developments thereof which realizes the aforementioned advantageous effects by means of technical features which correspond to the apparatus.

Embodiments of the invention according to claim 34 can be realized in accordance with the subclaims which refer back to this claim and in accordance with the remaining developments and embodiments of all the apparatuses and methods according to the invention.

The invention according to claim 40 provides an arrangement for the automated animation of a sequence of computer graphics forming pages of a digital document, having an apparatus according to claim 1 or one of the developments thereof and an apparatus according to claim 25 or one of the developments thereof. Correspondingly, it is also possible for the animation method according to claim 16 or one of the developments thereof and the provision method according to claim 34 or one of the developments thereof to be combined to produce a method.

The invention according to claim 41 provides a computer program product, which is stored on a computer-readable storage medium, and which contains computer-readable program means for the execution of the steps of the method according to the invention by a computer. The invention according to claim 42 accordingly provides a computer program product which is embodied in a digital carrier wave. By way of example, the digital carrier wave may be implemented by a wireless or wired electrical or optical signal or by all forms of the embodiment of the information-carrying bits in a medium. Both computer program products are used for carrying out the method when the program product is executed on a computer.

The computer program product may be stored in a corresponding fashion on a magnetic or optical data storage medium, such as a CD-ROM, DVD-ROM, floppy disk or hard disk, or in a semiconductor chip, such as a memory chip or a memory portion of a processor.

The invention according to claim 43 is a data structure product which is stored on a computer-readable storage medium and/or is embodied in a digital carrier wave, for an apparatus as claimed in claim 1 or one of the developments thereof, having a layout data record,
wherein the layout data record contains a first layout area having a background plane and a foreground plane and with a second layout area, which is opposite the first layout area, having a background plane and a foreground plane,
and wherein also the layout data record has an associated first, second, third and fourth computer graphic, wherein the first and second computer graphics form the open rectos of a double-sided digital document, and wherein the third and fourth computer graphics form the open rectos of the document after forward page-turning,
and wherein also the first computer graphic is associated with the foreground plane of the first layout area, the second computer graphic is associated with the foreground plane of the second layout area, the third computer graphic is associated with the foreground plane of the first layout area and the third computer graphic has an associated presentation width of approximately zero, and the fourth computer graphic is associated with the background plane of the second layout area.

The data structure product inherently has the technical characteristics and features of the apparatuses and methods according to the invention. As explained above, the layout data record designed in this specific manner, allows the animation by means of the subsequently performed steps of (re)association of graphics and step-by-step changing of the presentation width. The data structure product may be held on a computer-readable storage medium so that it can be read into the memory of a computer.

Embodiments of the invention according to claim 43 can be realized in accordance with the subclaims which refer back to this claim and in accordance with the remaining developments and embodiments of the apparatuses and methods according to the invention.

### BRIEF DESCRIPTION OF THE DRAWINGS

The invention is explained below by way of example with reference to a plurality of figures, in which:

FIG. 1 shows a schematic overview of an exemplary embodiment of an apparatus for animating the page-turning of computer-graphic pages of a digital document,

FIG. 2 shows a schematic overview of an exemplary embodiment of an apparatus for layout data record provision as a server and of an apparatus for the animation of computer-graphic pages as a client

FIG. 3 shows a schematic overview of an exemplary embodiment of the method for providing the layout data record,

FIG. 4 shows a schematic overview of a first portion of an exemplary embodiment of the animation method,

FIG. 5 shows a schematic overview of a second portion of an exemplary embodiment of the animation method,

FIG. 6 shows a schematic overview of a third portion of an exemplary embodiment of the animation method,

FIG. 7 shows a schematic overview of a fourth portion of an exemplary embodiment of the animation method,

FIG. 8 shows an exploded illustration of the layout areas with a horizontal page arrangement which are modeled in one exemplary embodiment,

FIG. 9 shows an exploded illustration of the layout areas with a vertical page arrangement which are modeled in one exemplary embodiment,

FIG. 10 shows an illustration of the association of the computer graphics in the illustration as shown in FIG. 8,

FIG. 11 shows a schematic illustration of the visual impression prior to the animation of the page-raising in a forward direction,

FIG. 12 shows a schematic illustration of the visual impression between two steps of the animation of the page-raising in a forward direction,

FIG. 13 shows a schematic illustration of the visual impression after the animation of the page-raising in a forward direction,

FIG. 14 shows a schematic illustration of the visual impression between two steps of the animation of the page-lowering in a forward direction,

FIG. 15 shows a schematic illustration of the visual impression after the animation of the page-lowering in a forward direction,

FIG. 16 shows a schematic illustration of the visual impression between two steps of the animation of the page-raising in a backward direction,

FIG. 17 shows a schematic illustration of the visual impression after the animation of the page-raising in a backward direction,

FIG. 18 shows a schematic illustration of the visual impression between two steps of the animation of the page-lowering in a backward direction, and

FIG. 19 shows a schematic illustration of the visual impression after the animation of the page-lowering in a backward direction.

### DETAILED DESCRIPTION

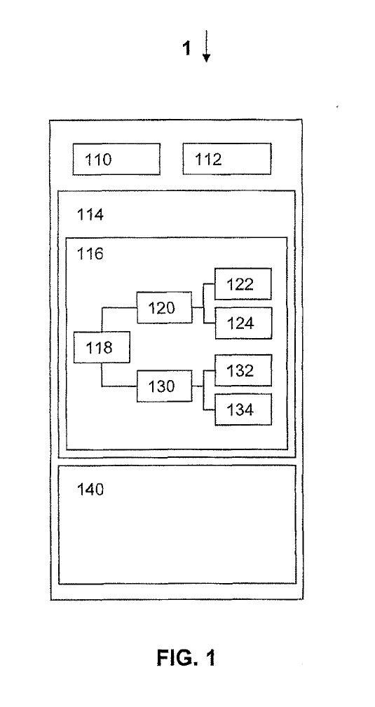

FIG. 1 shows a schematic overview of an exemplary embodiment of an apparatus for animating the page-turning of computer-graphic pages of a digital document.

The apparatus for animation 1 comprises a processing unit 110, a data communication unit 112, a memory 114 and a presentation unit 140 which are connected to one another by suitable communication means for data inter-change such as a bus.

The processing unit 110 comprises one or more processors or CPUs which are designed to provide the functionalities required for the animation and data conditioning and to perform the animation and data conditioning. The processing unit may also have been produced by means of program-based setup of a universal processor and/or graphic processor, or it may additionally have been produced in part or completely by specific hardware components (Application-Specific Integrated Circuits, ASICs).

The data communication unit 112 comprises a communication interface for transporting data via a wireless or wired network, such as the Internet, a Local Area Network (LAN) or Wide Area Network (WAN) with the processor and memory means required therefor. Functions of the data communication unit 112 may be realized by the processing unit 110. In the present case, the data communication unit 112 comprises a WWW client which is set up to use the Hypertext Transfer Protocol (HTTP) or the File Transfer Protocol (FTP) to retrieve data from a WWW server. The data communication unit may also contain a drive or a docking device for a removable medium.

The memory 114 may be formed completely or in part from Random Access Memory stores (RAM, SDRAM), hard-disk stores, solid-state drives or hybrid forms thereof. The memory contains a layout data record 116.

The layout data record 116 is a data-filled data structure which defines the arrangement of graphical elements on a page or a screen surface, and associates additional formatting and/or orientation information or further information with the graphical elements. In this context, graphical elements may be structure elements of the page which are themselves not presented, such as object frames, tables, levels and the like, or else inherently visually appearing presentation elements, such as computer graphics and text paragraphs. In the present case, the data structure is equipped with semantic means, such as data fields provided for this purpose or key expressions, e.g. tags, in order to assign a specific format to the graphical elements. In the present layout data record, the graphical elements described below are in this way specifically defined and may have specific formatting assigned to them.

The layout data record may therefore be a file with expressions from a Standard Generalized Markup Language (SGML), e.g. the Hypertext Markup Language (HTML), or from a subset of SGML, e.g. Extensible Markup Language (XML). In addition, the layout data record may be realized using a vector-based page description language, such as PostScript (PS) or Portable Document Format (PDF), into which appropriate markup elements (for tables, frames or further structures) have been embedded. In embodiments, the layout data record may also be a dynamic memory model in the apparatus which has been obtained by evaluating a file, e.g. in one of the aforementioned formats. Thus, an appropriate Document Object Model (DOM), for example, may have been obtained from an HTML or XML file as a dynamic memory model.

The layout data record 116 has been provided with a table element 118 (e.g. using the <TABLE> expression in HTML), wherein the table element is provided such that it defines a first layout area 120 and a second layout area 130, said first and second layout areas being opposite one another. In the case of vertical page-turning (that is to say page-turning around a binding which runs horizontally relative to the page orientation), this can be done by means of an upper (120) and a lower (130) table row (e.g. <tr> in HTML), or in the case of horizontal page-turning (around a binding which runs vertically relative to the page orientation), by means of a left-hand (120) and a right-hand (130) column (e.g. <td> in HTML). In this case, a row or column 120 is defined such that it has a background 122 (e.g., background value of the <tr> or <td> expression), which has had a computer graphic assigned to it by a reference statement, and a foreground 124 (e.g. statements in the <tr></tr> or <td></td> expression, or <td></td> expression contained in the <tr></tr> expression in HTML), to which a plurality of computer graphics can be assigned by reference.

The layout data record can be received via the data communication unit 112.

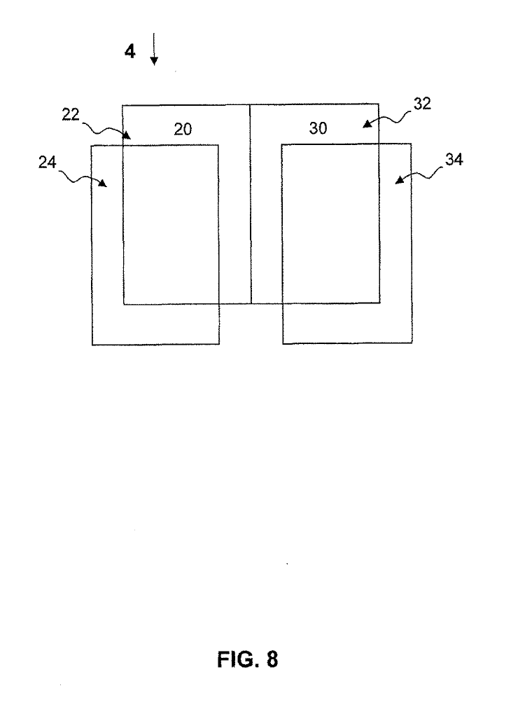

Statements about the specific assignment of the computer graphics to the foreground and background areas 122 and 124, and 132 and 134 of the layout areas 120 and 130 and also the specific assignment of further formatting attributes in the layout data record 116 are given below with reference to FIG. 8 et seqq.

The presentation unit 140 is designed to take the layout data record (as an SGML/XML/HTML file, as a PDF/PS data file or as a dynamic memory model produced from such files, e.g. DOM) and use rendering to produce a graphical representation of the arrangement of graphical elements which is defined by the layout data record. For this, the presentation unit may also contain the requisite display means and display actuation means, such as screen, graphics card and graphics driver. The presentation unit may have a WWW browser, the functions of which can be realized at least in part also by the processing unit 110 set up by means of programming.

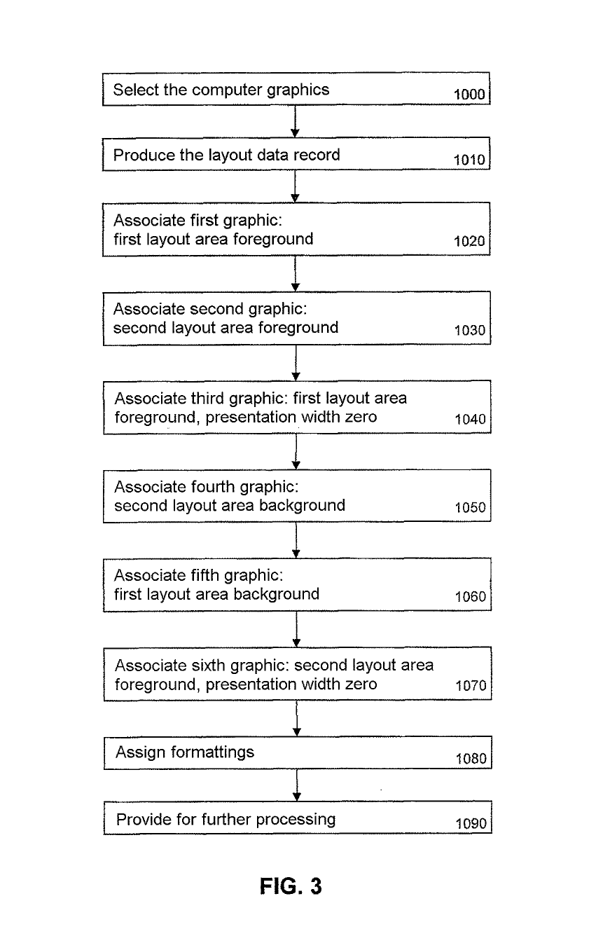

In this way, the apparatus 1 is designed to process the formatted graphical elements modeled in the layout data record 116 and provided with attributes to produce an animation. The specific manner of operation of the components is described in more detail with reference to the method and to FIGS. 3 to 7.

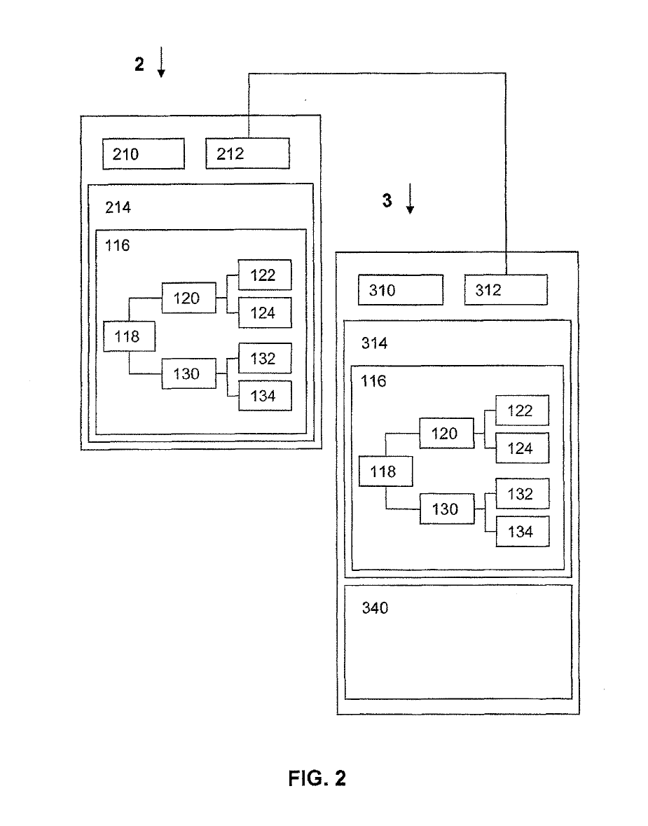

In addition, the processing unit 110 may be designed to select the six computer graphics to be animated and to produce a layout data record 116 in the memory 114 as appropriate, as illustrated below for the provision apparatus 2 in FIG. 2 and in the method shown in FIG. 3. In such a standalone implementation, the computer graphics could be received via the data communication unit.

FIG. 2 shows a schematic overview of an exemplary embodiment in an arrangement having a server 2 and a client 3.

In one variant embodiment, this may involve the server 2 being in the form of an apparatus for layout data record provision and the client 3 being in the form of an apparatus for animating computer-graphic pages.

The apparatus for providing the layout data record 2 comprises a processing unit 210, a data communication unit 212 and a memory 214, which correspond to the devices of the same name in FIG. 1 according to their nature. The processing unit 210 is set up to select the six computer graphics to be animated and to produce a layout data record 116 in the memory 214 as appropriate for the associated assignments, formattings and attributes, as illustrated below for the method shown in FIG. 3.

The data communication unit 212 can be formed by a web server or an FTP server, which can be realized at least in part also by program-based setup of the processing unit 210, and which provides the layout data record 116 for retrieval via a network. The layout data record 116 and the elements 118 to 134 contained therein correspond to those described in FIG. 1.

The apparatus for providing the layout data record 2 is connected to the data communication unit 312, in this case a web client, of the apparatus for animation 3 via the web server 212 and a network. Using the web client 312, the apparatus for animation 3 can retrieve a layout data record 116 from the provision apparatus 2.

The apparatus for animation 3 also comprises a processing unit 310, a memory 314 and a presentation unit 340, which correspond to the units of the same name in the remaining apparatuses, particularly those shown in FIG. 1, according to their nature. The processing unit 310 is set up to process the graphical elements which have been modeled in the layout data record 116, provided with assignments and attributed to produce an animation, as described in more detail with reference to the method and FIGS. 3 to 7.

In one variant embodiment—which is not shown in more detail in FIG. 2—the server 2 may also be designed as an apparatus for layout data record provision and animation simultaneously, the functions and methods being combined as appropriate in the server 2, and the web server 212 being used to transmit the individual, already animated computer graphics (elements) in the sequence of movement phases to the web client of the client 3 on demand. In this case, the graphics are then presented visually in the client 3 using the presentation unit 340.

In the case of such server-end animation, the animation can be implemented by server-end script, for example PERL or PHP. Client-end animation can be implemented by client-end scripts, for example ECMAScript or JavaScript.

FIG. 3 shows a schematic overview of an exemplary embodiment of the method for providing the layout data record which is performed by the processing unit in a provision apparatus 2 as shown in FIG. 2, or a standalone solution in a variant as shown in FIG. 1.

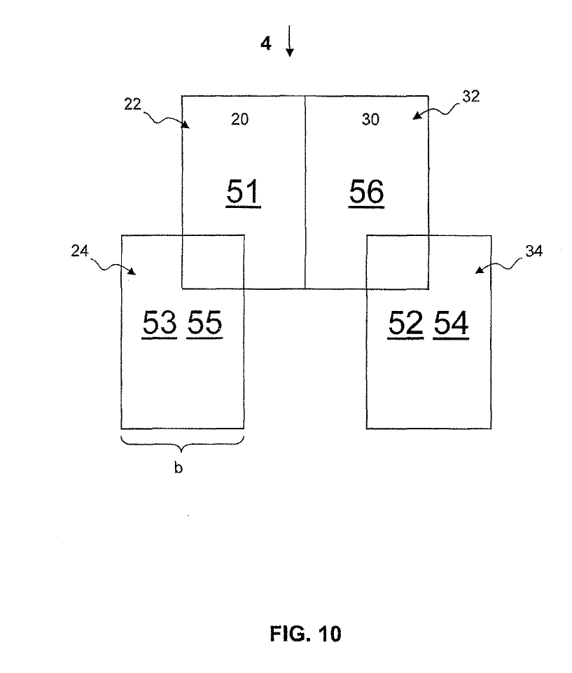

In step 1000, the processing unit first of all selects six computer graphics (51 to 56 in FIG. 10), wherein each computer graphic forms a page of a digital document, and the computer graphics 51 to 56 are organized in a sequence which corresponds to the page sequence of a double-sided digital document.

In step 1010, the processing unit then produces a layout data structure and provides it with two mutually opposite layout areas by generating a table structure having two columns. In this case, each layout area has a foreground plane and a background plane defined in it.

The layout data structure has been shown schematically from the implementation point of view with reference to FIGS. 1 to 3.

To simplify understanding and to improve clarity, the text below illustrates the respective associated visual results for the method steps in FIG. 8 et seqq.

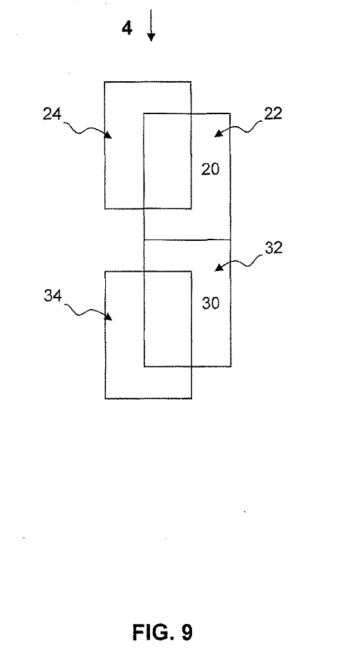

FIG. 8 shows schematically an exploded illustration of the visual result of the graphical elements defined by the layout data structure. The two layout areas realized by mutually adjacent table columns 20 and 30 have a respective background plane 22 or 32 and a respective foreground plane 24 or 34. In an actual view, the foreground planes are each exactly above the background planes. FIG. 9 shows an alternative, in which the opposite layout areas 20 and 30 are realized by table rows situated above one another.

The text below outlines the method and the visual interim and final results for layout areas situated beside one another, the page-turning taking place in a horizontal direction, i.e. around a binding which runs vertically. The presentation width of the graphics accordingly extends in a horizontal direction. In embodiments in which the layout areas are situated above one another, the page-turning takes place in a vertical direction, i.e. around a binding which runs horizontally. In such embodiments the presentation width of the graphics extends in a vertical direction. By way of example, a WIDTH-HTML attribute is replaced accordingly by a HEIGHT attribute.

Again with reference to FIG. 3 and FIG. 10, the processing unit now assigns the first graphic 53 to the foreground plane 24 with the left-hand table column in step 1020. The first graphic forms (in this case and also in the case of the remaining graphics, without limiting the general nature) the left-hand page of the opposite, open pages of the double-sided document. In this case, said page has its full presentation width associated with it, i.e. a presentation width which corresponds to the full width of the layout area, so that the computer graphic is initially presented as a left-hand open page.

In step 1030, the processing unit assigns the second graphic 54 to the foreground plane 34 in the right-hand table column, the second graphic 54 in this case representing the right-hand page of the opposite, open pages of the double-sided document. Said page also has its full presentation width associated with it, so that the computer graphic is initially presented as right-hand open page.

In step 1040, the processing unit likewise assigns the third graphic 55 to the foreground plane 24 in the left-hand table column, such that it is positioned beside the already associated graphic 53. The third graphic forms the left-hand page of the opposite, open pages of the double-sided document after the animation of the forward page-turning has been performed. Said page first of all has a presentation width of approximately zero associated with it, so that the computer graphic is initially not presented or is presented so that it practically cannot be seen.

In step 1050, the processing unit assigns the fourth graphic 56 to the background plane 32 in the right-hand table column, and assigns a full presentation width. The fourth graphic forms the right-hand page of the opposite, open pages of the double-sided document after the animation of the forward page-turning has been performed. This graphic is initially covered substantially by the second graphic 54 presented in the foreground, so that it becomes invisible or visible only in marginal areas.

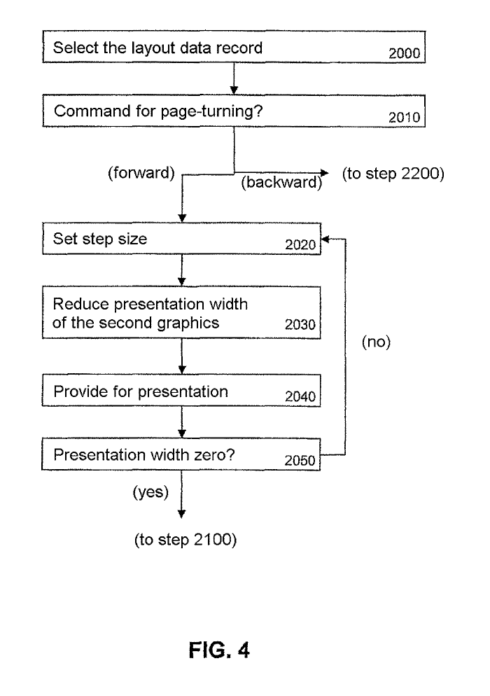

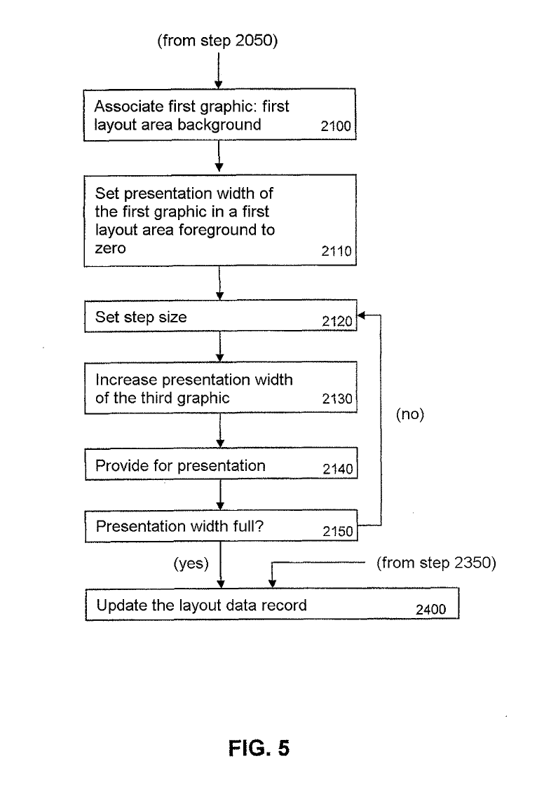

Up until this time, the layout data record itself has been provided and the computer graphics have been assigned and arranged by means of format information contained in the layout data record such that forward page-turning can be performed as described in more detail in FIGS. 4 and 5.

However, since, in the present exemplary embodiment, backward page-turning is also intended to be made possible without the need for data then to be reloaded for this purpose, the processing unit assigns the fifth graphic 51 to the background plane 22 in the left-hand table column, with full presentation width in step 1060. The fifth graphic forms the left-hand page of the opposite, open pages of the double-sided document after the animation of the backward page-turning has been performed. This graphic is initially covered substantially by the first graphic 53 presented in the foreground, so that it becomes invisible or visible only in marginal areas.

In step 1070, the processing unit likewise assigns the sixth graphic 52 to the foreground plane 34 in the right-hand table column, such that it is positioned beside the already associated graphic 54, specifically such that it is arranged between the graphic 54 and the binding edge of the double-sided document, that is to say toward the inside. The third graphic forms the right-hand page of the opposite, open pages of the double-sided document after the animation of the backward page-turning has been performed. Said page then first of all has a presentation width of approximately zero associated with it, so that the computer graphic is initially presented so that it cannot be seen or practically cannot be seen.

In step 1080, the graphical elements managed in the layout data record have further formatting attributes associated with them by the processing unit. Thus, the computer graphics in the layout data record have orientation attributes associated with them, so that the computer graphics in the left-hand column are always placed in a flush-right orientation and the computer graphics in the right-hand column are always placed in a flush-left orientation. When the binding runs horizontally, the computer graphics in the layout data record have orientation attributes associated with them accordingly, so that the computer graphics in the upper row are always placed in a downward orientation and the computer graphics in the lower row are always placed in an upward orientation.

In step 1090, the layout data record prepared in this manner in the memory is provided for further processing, possibly together with the computer graphics referenced by it. This may involve the use of means for interprocess communication (in the case of standalone solutions or in the case of server-end animation) or a web or FTP server (in the case of provision on a server and animation on a client).

FIG. 4 shows a schematic overview of a first portion of an exemplary embodiment of the animation method.

In step 2000, the processing unit selects the layout data record created as appropriate on the basis of the method described with reference to FIG. 3.

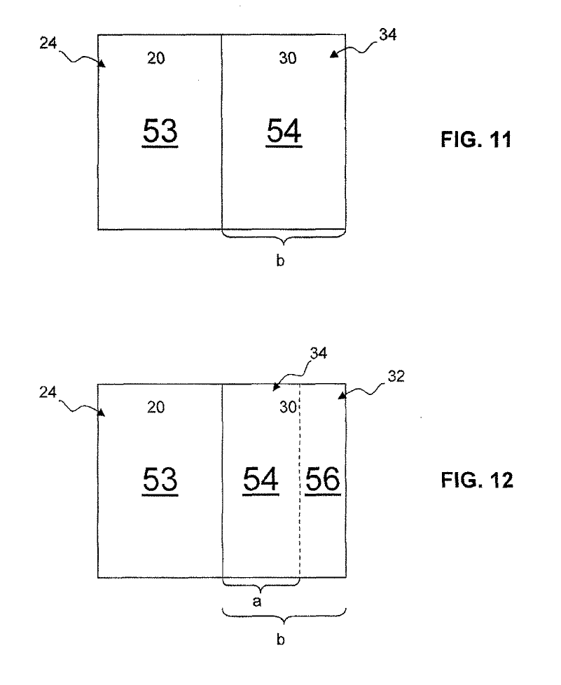

In a manner which is not described in more detail in the present case, the presentation unit has presented the page basic presentation in accordance with the layout data record and the associated computer graphics as shown in FIG. 11. The formattings set in the layout data record mean that the two foreground planes 24 and 34 in the table columns 20 and 30 are visible, and therein the respective computer graphics 53 and 54 set to full presentation width b. This presents the two document pages which are open first.

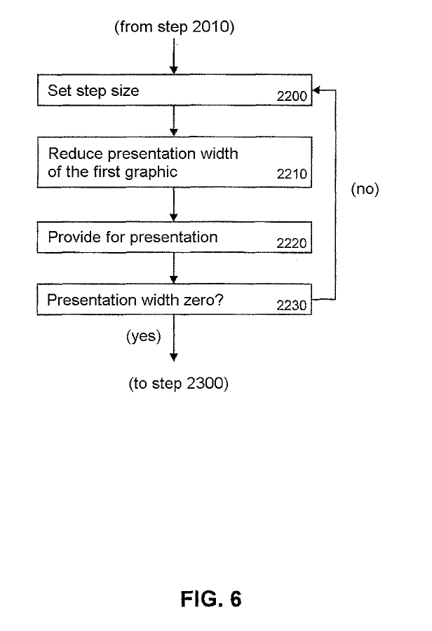

In step 2010, the processing unit evaluates a page-turning command which has been produced by user interaction or programming. If the result of the evaluation is ascertainment of the case in which a command for forward page-turning has arisen, the processing device continues at step 2020, and in the case of backward page-turning at step 2200, which is explained later with reference to FIG. 6.

In step 2020, the processing unit first of all sets a step size for the animation, which will take place in a plurality of graphical steps, or phases. This determines the size of the visibly perceived progress of each animation phase of the page-turning by stipulating the width difference which occurs in each step of the step-by-step alteration of the presentation width. Alternatively or simultaneously, it is also possible for a delay step to take place, the duration of which can be stipulated within this context. In the course of the duration of steps 2020 to 2050, the step size and the delay time can be adapted, for example in order to adapt to technically determined hardware limitations or to achieve dynamic page-turning effect.

In step 2030, the processing unit now reduces the presentation width of the computer graphic 54 by the magnitude of the step size to a reduced presentation width a.

If the processing device now provides the altered layout data record for the presentation unit in step 2040 for the purpose of rendering, the presentation unit presents the second computer graphic (as shown in FIG. 12) using the reduced presentation width a and with appropriate compression of the graphic contents, which corresponds to the view of a tilted page. At the same time, the (uncompressed) fourth computer graphic 56 arranged in the background plane 32 with its full width becomes visible, provided that the foreground graphic no longer conceals the background.

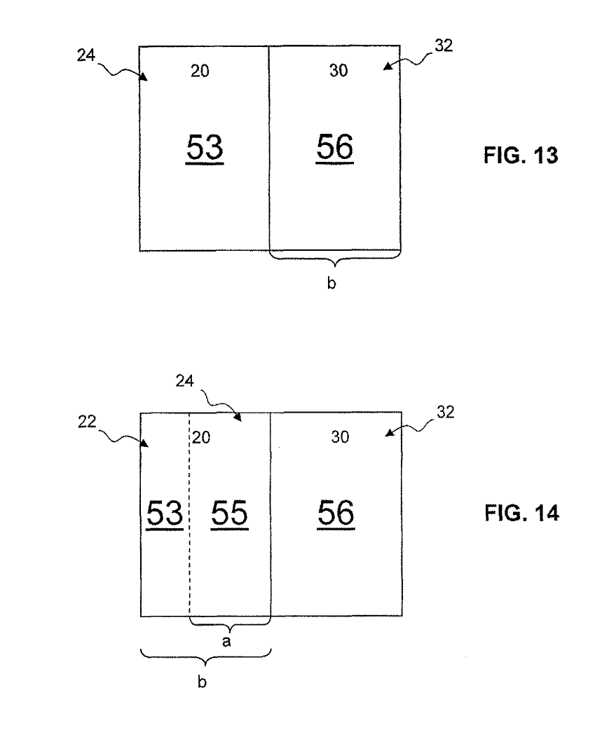

If step 2050 establishes that the presentation width a of the compressed second computer graphic 54 is not yet zero, the method is repeated from step 2020 until the presentation width a is approximately zero, i.e. until the second computer graphic 54 is no longer visible and the fourth computer graphic 56 in the background 32 is completely visible. The state then represented by the layout data record is shown in FIG. 13.

Once the method section of raising the right-hand page is then complete, the method section of page-lowering is initiated from step 2100, which is illustrated in more detail in FIG. 5.

In step 2100, the processing unit for this purpose assigns the first computer graphic 53, already associated with the left-hand foreground 24, to the left-hand background 22; while preserving the full presentation width d, such that the first computer graphic 53 now replaces the fifth computer graphic 51 in the left-hand background 22.

In step 2110, the processing unit then assigns a presentation width of approximately zero to the first computer graphic 53, which is associated with the left-hand foreground 24, so that, although appropriate rendering and presentation first of all produce the same graphical representation as in FIG. 13, the left-hand background 22 is visible instead of the left-hand foreground 24.

In step 2120, the processing unit then determines a step size or a step delay in accordance with step 2020.

In step 2130, the processing unit then increases the presentation width associated with the third graphic 55 in the left-hand foreground 24, initially from approximately zero, to an intermediate value a. The difference between the full presentation width b of the computer graphic and the current presentation width a again produces a compression for the computer graphic contents of the graphic 55 in this case. The graphic 53 in the background 22, which is increasingly covered by the graphic 55 in the left-hand foreground 24, remains uncompressed.

In step 2140, the processing unit accordingly provides the altered layout data record for the presentation unit for the purpose or rendering.

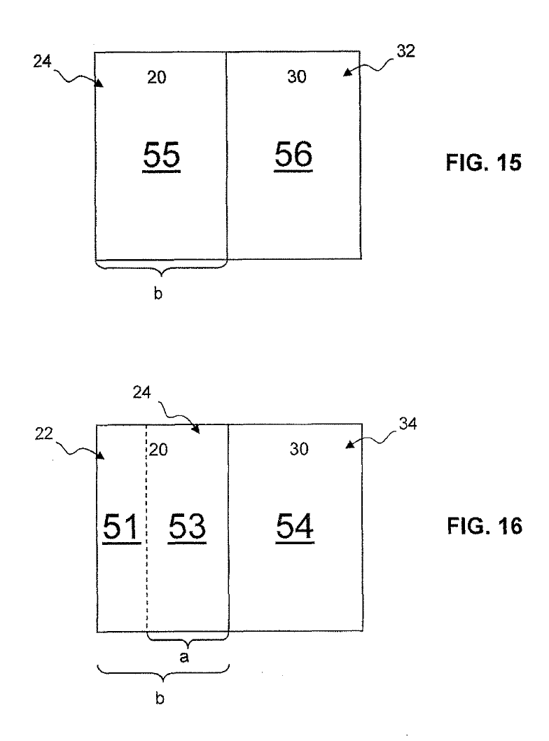

If step 2150 establishes that the presentation width a of the compressed second computer graphic 54 has not yet reached the full width b, the method is repeated from step 2120 until the presentation width a is approximately equal to b, i.e. until the third computer graphic 55 is fully visible and the first computer graphic 53 in the background 22 is completely covered. The state then represented by the layout data record is shown in FIG. 15.

Hence, the operation of forward page-turning with a first section of page-raising and a second section of page-lowering for the turned page is realized in a very memory-efficient manner and using widely available technical means by virtue of the computer graphics being assigned and arranged in a particularly suitable manner and, for this purpose, the animation being able to be realized in a particularly small number of memory-space-efficient operations.

FIG. 6 shows the method section of page-raising when a command for backward page-turning has been ascertained in step 2010.

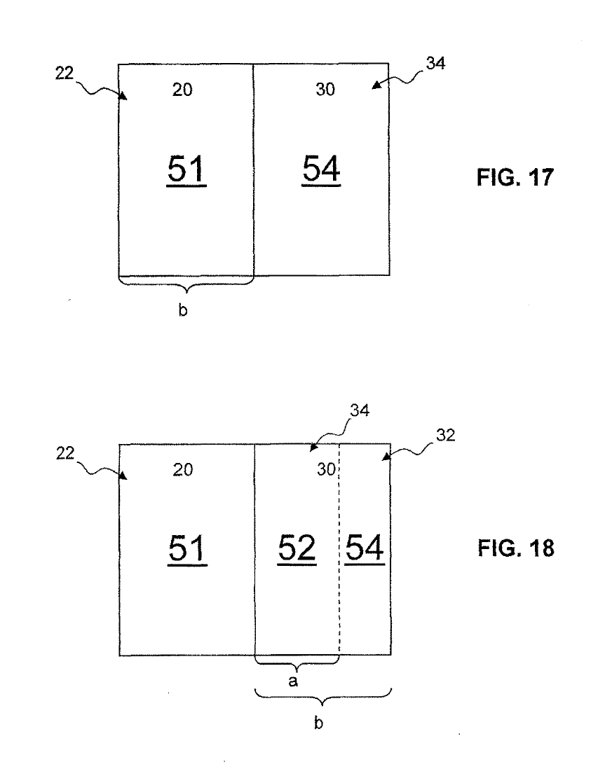

Starting from the situation shown in FIGS. 10 and 11, the presented width of the first computer graphic 53 in the left-hand foreground 24 is iteratively reduced in steps 2200 to 2230 with a variable step size and speed by the processing unit, and the view of the first computer graphic positioned in the left-hand background is increasingly uncovered, as shown in FIG. 16 until the first computer graphic has a presentation width of approximately zero and the state shown in FIG. 17 is produced. In this case the details of method steps 2200 to 2230, which therefore animate page-raising during backward page-turning, correspond to steps 2020 to 2050, explained for page-raising during forward page-turning.

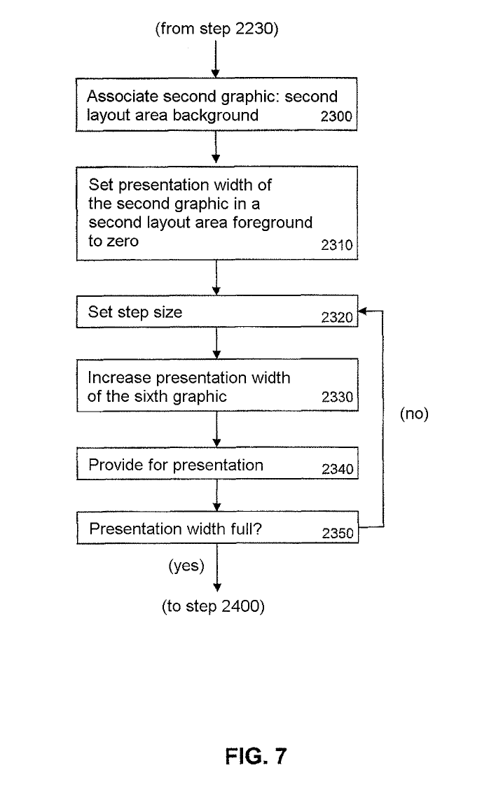

FIG. 7 shows a schematic overview of a fourth portion of an exemplary embodiment of the animation method which prepares and performs the page-lowering during backward page-turning.

In step 2300, the second computer graphic 54, which is associated with the right-hand foreground 34, is first of all associated with the right-hand background 32 by the processing unit such that the second computer graphic now replaces the fourth computer graphic 56 and it is provided with the full presentation width b in the background.

In step 2310, the processing unit then sets the presentation width of the second computer graphic 54, which is associated with the foreground, to approximately zero.

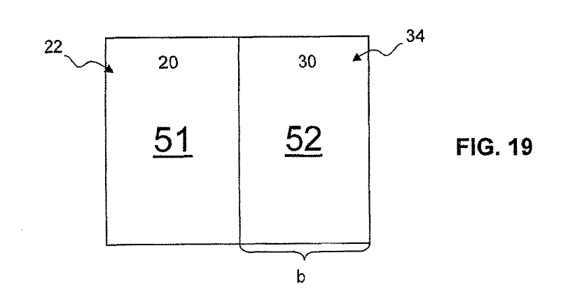

In steps 2320 to 2350, the processing unit then iteratively increases the presented width of the sixth computer graphic 52 in the right-hand foreground 34 with a variable step size and speed, and increasingly conceals the view of the second computer graphic 54 positioned in the right-hand background 32, as shown in FIG. 18, until the sixth computer graphic has approximately reached its full presentation width and the state shown in FIG. 19 is produced. The details of method steps 2300 to 2350, which therefore animate page-lowering during backward page-turning, correspond to steps 2100 to 2150, explained for the page-lowering during forward page-turning.

In step 2400, a new layout data record is finally requested or produced locally, or the existing layout data record is updated with new computer graphics such that the pages which are open as a result of the page-turning operation (51 and 52 following backward page-turning, or 55 and 56 following forward page-turning) form the first and second computer graphics of the updated layout data record, and the respective subsequent pair of pages in the page sequence form the third and fourth, and the respective preceding pair of pages in the page sequence form the fifth and sixth, computer graphics of the updated layout data record, to which the page-turning method can be applied afresh.

If the size of the page graphic exceeds the size which can be presented on the screen when double-sided presentation is being used, the method can be used to present one of the two layout areas, particularly for page-raising. If the number or the order of the pages contained in the digital document does not correspond to the present scheme of three successive pairs of pages, pages which are missing in the digital document can be replaced by transparent graphics. In order to achieve faster page setup, a graphic preload can additionally be started after each page has been loaded in order to put the next required graphics into the buffer store of the WWW browser in advance.

In order to present the transition to the next page after the concluded operation smoothly on all browsers without occurrence of spurious slashing effects, for example, it is possible to use transitions or “flowing page transitions” coordinated on a browser-specific basis, such as transition effect 12 “crumbling effect in all directions”.

The proposed system animates the page-turning operation in digital documents presented by computer graphics, and, on the basis of the special association between the computer graphics and the layout data record, allows the animation operation to be realized by computation- and memory-efficient association and attribute stipulation operations, which can be implemented with low technical complexity on widely used technical platforms.

As a person skilled in the art can easily glean from the preceding illustrations and explanations, embodiments may comprise both systems in which the animation functions and the data conditioning operations required therefor are integrated on an appliance in a position of the user (described with reference to FIG. 1 and the method description) and systems in which the data conditioning functions required for the animation are arranged on a system component which is remote from the user, such as a server, while the animation functions are implemented on the appliance which is in the possession of the user, in such a case a client (described with reference to FIG. 2 and the method description).

The animation and data conditioning functionalities may, in an implementation as described with reference to FIG. 1, be implemented in a piece of software which contains instructions, said piece of software realizing the features of the described method and being contained in the memory 114 (not shown).

Accordingly, in an implementation as described with reference to FIG. 2, the data conditioning functionalities may be implemented in a piece of data conditioning software which implements the method features of the method portion described with reference to FIG. 3 and which is contained in the memory 214 (not shown), and also the animation functionalities may be implemented in a piece of animation software which implements the method features of the method proportion described with reference to FIGS. 4 to 7 and which is contained in the memory 314.

As a person skilled in the art will readily glean from the description above, the software can be executed on a general-purpose processor and in so doing resort to functions and commands which are provided by well-established Internet technologies, such as by a web browser, or web servers (e.g. JavaScript, PHP).

Thus, the apparatuses 1 and 3 may each be realized using a web browser installed on a static or mobile computer, which web browser receives the page graphics to be displayed together with JavaScript commands for the animation from a web server. In such implementations, the software described above can therefore be put into the memory of the apparatus 1 and 3 and executed therein by the browser when presenting the WWW page.

In systems in which the animation functions and data conditioning operations required therefor are integrated on an appliance which is in the possession of the user (described with reference to FIG. 1 and the method description), the commands for data conditioning (data conditioning software) and for animation (animation software) and the page graphics to be presented are sent by a web server and received by a web client, for example, and the layout data structure is set up in the web client (dynamic DOM structure) and presented as an animation.

In systems in which the data conditioning functions required for the animation are arranged on a system component (for example web server) which is remote from the user, while the animation functions are implemented on the appliance which is in the possession of the user (for example web client) (described with reference to FIG. 2 and the method description) the completed layout data structure in the form of an HTML or XML or SGML file, the commands for animation (animation software) and the page graphics to be presented are sent by web server and received by a web client and presented as animation.

As a person skilled in the art will also see easily, the present system can work with a variety of different memory and provision types of graphical digital documents. The page graphics may be stored in a database, for example, as a succession of graphic pages in an Adobe PDF document, or in other types of documents with pages encoded as a graphic, or can be produced dynamically. The page graphics can equally be stored in a file system provided with suitable file and/or directory structures.

In this way, the proposed solution can be realized on widely-used presentation devices, such as WWW browsers, without placing the burden of particular additional effort on a user. Thus, a WWW browser calling an appropriate WWW page can be equipped with the layout data structure in the form of an HTML page together with associated graphics, and the browser can be set up in the same way with script programs which are suitable for executing the animation operation, such as JavaScript.

### LIST OF REFERENCE SYMBOLS

1 Apparatus and arrangement for automated animation
2 Apparatus for providing a layout data record
3 Apparatus for automated animation
4 Layout data record
20 First layout area
22 Background plane of the first layout area
24 Foreground plane of the first layout area
30 Second layout area
32 Background plane of the second layout area
34 Foreground plane of the second layout area
51 Fifth computer graphic (page 1 in a page sequence)
Sixth computer graphic (page 2 in a page sequence)
First computer graphic (page 3 in a page sequence)
Second computer graphic (page 4 in a page sequence)
Third computer graphic (page 5 in a page sequence)
Fourth computer graphic (page 6 in a page sequence)
110, 210, 310 Processing unit
112, 212, 312 Data communication unit
114, 214, 314 Memory
116 Layout data record
118 Table element
120 First layout area of the table element
122 Background graphic element of the first layout area
124 Foreground graphic element of the first layout area
130 Second layout area of the table element
132 Background graphic element of the second layout area
134 Foreground graphic element of the second layout area
140, 340 Presentation unit
1000 Select the computer graphics
1010 Produce the layout data record
1020 Associate first graphic
1030 Associate second graphic
1040 Associate third graphic and presentation width
1050 Associate fourth graphic
1060 Associate fifth graphic
1070 Associate sixth graphic
1080 Assign the formatting to graphics
1090 Provide the layout data record for further processing
2000 Select the layout data record
2010 Evaluate command for page-turning
2020 Set step size
2030 Reduce presentation width of the second graphic
2040 Provide the layout data record for presentation
2050 Check whether presentation width zero reached
2100 Associate the first graphic with the background
2110 Set presentation width to zero
2120 Set step size
2130 Increase presentation width of the third graphic
2140 Provide the layout data record for presentation
2150 Check whether full presentation width reached
2200 Set step size
2210 Reduce presentation width of the first graphic
2220 Provide the layout data record for presentation
2230 Check whether presentation width zero reached
2300 Associate the second graphic with the background
2310 Set presentation width to zero
2320 Set step size
2330 Increase presentation width of the sixth graphic
2340 Provide the layout data record for presentation
2350 Check whether full presentation width reached
2400 Update layout data record

1. An apparatus (1, 3) for the automated animation of a sequence of computer graphics (51-56) which form pages of a digital document, having a processing unit (110, 310) and a memory (114, 314)
characterized in that
the memory has a layout data record (4, 116), and the layout data record contains a first layout area (20, 120) having a background plane (22, 122) and a foreground plane (24, 124) and contains a second layout area (30, 130), which is opposite the first layout area, having a background plane (32, 132) and a foreground plane (34, 134);
the layout data record has an associated first (53), second (54), third (55) and fourth (56) computer graphic;
the first computer graphic is associated with the foreground plane of the first layout area, the second computer graphic is associated with the foreground plane of the second layout area, the third computer graphic is associated with the foreground plane of the first layout area and the third computer graphic has an associated presentation width of approximately zero, and the fourth computer graphic is associated with the background plane of the second layout area;
the processing unit is designed to reduce the presentation width (a, b) of the second computer graphic in steps while providing the layout data record for presentation;
the processing unit is designed to associate the first computer graphic with the background plane of the first layout area;
the processing unit is designed to associate a presentation width of approximately zero with the first computer graphic, which is associated with the foreground plane of the first layout area;
the processing unit is designed to increase the presentation width (a, b) of the third computer graphic in steps while providing the layout data record for presentation.

2. The apparatus as claimed in claim 1, characterized in that the processing unit is designed to alter the step size in the course of the step-by-step reduction of the presentation width of the second computer graphic.

3. The apparatus as claimed in claim 2, characterized in that the processing unit is designed to increase the step size as the presentation width of the second computer graphic decreases.

4. The apparatus as claimed in one of claims 1 to 3, characterized in that the processing unit is designed to alter the interval of time between two successive steps of the step-by-step reduction of the presentation width of the second computer graphic.

5. The apparatus as claimed in claim 4, characterized in that the processing unit is designed to reduce the interval of time as the presentation width decreases.

6. The apparatus as claimed in one of claims 1 to 5, characterized in that the layout data record is in a form such that the computer graphics associated with the first layout area are oriented toward the second layout area.

7. The apparatus as claimed in one of claims 1 to 6, characterized in that the layout data record is in a form such that the computer graphics associated with the second layout area are oriented toward the first layout area.

8. The apparatus as claimed in one of claims 1 to 7, characterized in that the layout data record is in a form such that the first layout area and the second layout area form an interface.

9. The apparatus as claimed in one of claims 1 to 8, characterized in that
the layout data record has an associated fifth (51) and sixth (52) computer graphic;
the fifth computer graphic is associated with the background plane of the first layout area, the sixth computer graphic is associated with the foreground plane of the second layout area and the sixth computer graphic has an associated presentation width of approximately zero;
the processing unit is designed to reduce the presentation width of the first computer graphic in steps while providing the layout data record for presentation;
the processing unit is designed to associate the second computer graphic with the background plane of the second layout area;
the processing unit is designed to associate a presentation width of approximately zero with the second computer graphic, which is associated with the foreground plane of the second layout area;
the processing unit is designed to increase the presentation width of the sixth computer graphic in steps while providing the layout data record for presentation.

10. The apparatus as claimed in one of claims 1 to 9, characterized in that the layout data record is designed at least to some extent using an SGML.

11. The apparatus as claimed in claim 10, characterized in that the layout data record is designed at least to some extent using HTML.

12. The apparatus as claimed in one of claims 1 to 11, characterized in that the layout data record has a table element (118) having at least one first column (20, 120) and at least one second column (30, 130), wherein the first column comprises the first layout area and the second column comprises the second layout area.

13. The apparatus as claimed in one of claims 1 to 11, characterized in that the layout data record has a table element (118) having at least one first row (20, 120) and at least one second row (30, 130), wherein the first row comprises the first layout area and the second row comprises the second layout area.

14. The apparatus as claimed in one of claims 12 and 13, characterized in that the table element is designed to reference at least one background graphic element (22, 32, 122, 132) and at least one foreground graphic element (22, 32, 122, 132), and the background graphic element comprises the background plane and the foreground graphic element comprises the foreground plane.

15. The apparatus as claimed in one of claims 1 to 14, characterized in that the processing unit is designed to execute a script language program in order to associate the presentation width and/or to reduce and/or increase it in steps.

16. A method for the automated animation of a sequence of computer graphics forming pages of a digital document, for an apparatus as claimed in one of claims 1 to 15, characterized in that it has the following steps:
a layout data record is selected (2000), wherein the layout data record contains a first layout area (20, 120) having a background plane (22, 122) and a foreground plane (24, 124) and contains a second layout area (30, 130), which is opposite the first layout area, having a background plane (32, 132) and a foreground plane (34, 134),
and wherein the layout data record also has an associated first, second, third and fourth computer graphic,
and wherein also the first computer graphic is associated with the foreground plane of the first layout area, the second computer graphic is associated with the foreground plane of the second layout area, the third computer graphic is associated with the foreground plane of the first layout area and the third computer graphic has an associated presentation width of approximately zero, and the fourth computer graphic is associated with the background plane of the second layout area;
the presentation width of the second computer graphic is reduced (2020-2050) in steps;
the first computer graphic is associated (2100) with the background plane of the first layout area;
the presentation width of the first computer graphic, which is associated with the foreground plane of the first layout area, is set (2110) to approximately zero;
the presentation width of the third computer graphic is increased (2120-2150) in steps,
wherein the presentation width of the second computer graphic is reduced in steps and the presentation width of the third computer graphic is increased in steps to provide (2040, 2140) the layout data record for presentation.

17. The method as claimed in claim 16, characterized in that the step size is altered (2020) in the course of the step-by-step reduction of the presentation width of the second computer graphic.

18. The method as claimed in claim 17, characterized in that the step size is increased as the presentation width (a) of the second computer graphic decreases.

19. The method as claimed in one of claims 16 to 18, characterized in that the interval of time between two successive steps of the step-by-step reduction (2030) of the presentation width of the second computer graphic is altered.

20. The method as claimed in claim 19, characterized in that the interval of time is reduced as the presentation width (a) decreases.

21. The method as claimed in one of claims 16 to 20, characterized in that the layout data record is selected such that the computer graphics associated with the first layout area are oriented toward the second layout area.

22. The method as claimed in one of claims 16 to 21, characterized in that the layout data record is selected such that the computer graphics associated with the second layout area are oriented toward the first layout area.

23. The method as claimed in one of claims 16 to 22, characterized in that the layout data record is selected such that the first layout area and the second layout area form an interface.

24. The method as claimed in one of claims 16 to 23, characterized in that
the layout data record is selected such that the layout data has an associated fifth and sixth computer graphic,
wherein also the fifth computer graphic is associated with the background plane of the first layout area, the sixth computer graphic is associated with the foreground plane of the second layout area and the sixth computer graphic has an associated presentation width of approximately zero,
and also the following steps are included:
the presentation width of the first computer graphic is reduced (2200-2230) in steps;
the second computer graphic is associated (2300) with the background plane of the second layout area;
the presentation width of the second computer graphic, which is associated with the foreground plane of the second layout area, is set (2310) to approximately zero;
the presentation width of the sixth computer graphic (2320-2350) is increased in steps,
wherein the presentation width of the first computer graphic is reduced in steps and the presentation width of the sixth computer graphic is increased in steps to provide (2220, 2340) the layout data record for presentation.

25. An apparatus (2) for providing a layout data record for an apparatus as claimed in one of claims 1 to 15, having a processing unit (210) and a memory (214), characterized in that
the processing unit is designed to select a first (53), second (54), third (55) and fourth (56) computer graphic;
the processing unit is designed to produce a layout data record (116) in the memory and to provide the layout data record with a first layout area (20, 12) having a background plane (22, 122) and a foreground plane (24, 124) and with a second layout area (30, 130), which is opposite the first layout area, having a background plane (32, 132) and a foreground plane (34, 134);
the processing unit is designed to associate the first computer graphic with the foreground plane of the first layout area, to associate the second computer graphic with the foreground plane of the second layout area, to associate the third computer graphic with the foreground plane of the first layout area and to associate a presentation width of approximately zero with the third computer graphic, and to associate the fourth computer graphic with the background plane of the second layout area.

26. The apparatus as claimed in claim 25, characterized in that
the processing unit is designed to select a fifth (51) and sixth computer graphic (52);
the processing unit is designed to associate the fifth computer graphic with the background plane of the first layout area, to associate the sixth computer graphic with the foreground plane of the second layout area and to associate a presentation width of approximately zero with the sixth computer graphic.

27. The apparatus as claimed in one of claims 25 and 26, characterized in that the processing unit is designed to orient the computer graphics associated with the first layout area toward the second layout area.

28. The apparatus as claimed in one of claims 25 to 27, characterized in that the processing unit is designed to orient the computer graphics associated with the second layout area toward the first layout area.

29. The apparatus as claimed in one of claims 25 to 28, characterized in that the processing unit is designed to produce the layout data record at least to some extent using an SGML.

30. The apparatus as claimed in claim 29, characterized in that the processing unit is designed to produce the layout data record at least to some extent using HTML.

31. The apparatus as claimed in one of claims 25 to 30, characterized in that the processing unit is designed to produce a table element (118) having at least one first (20, 120) and at least one second column (30, 130) in the layout data record, wherein the first column comprises the first layout area and the second column comprises the second layout area.

32. The apparatus as claimed in one of claims 25 to 30, characterized in that the processing unit is designed to produce a table element having at least one first and at least one second row in the layout data record, wherein the first row comprises the first layout area and the second row comprises the second layout area.

33. The apparatus as claimed in one of claims 31 and 32, characterized in that the processing unit is designed to produce at least one background graphic element (22, 32, 122, 132) and at least one foreground graphic element (24, 34, 124, 134) in the table element, and the background graphic element comprises the background plane and the foreground graphic element comprises the foreground plane.

34. A method for an apparatus as claimed in one of claims 25 to 33, for providing a layout data record characterized in that it has the following steps:
a first, second, third and fourth computer graphic are selected (1000);
a layout data record (116) is produced (1010) in the memory, and a first layout area (20, 120) having a background plane (22, 122) and a foreground plane (24, 124) and a second layout area (30, 130), which is opposite the first layout area, having a background plane (32, 132) and a foreground plane (34, 134) are provided in the layout data record;
the first computer graphic is associated (1020) with the foreground plane of the first layout area;
the second computer graphic is associated (1030) with the foreground plane of the second layout area;
the third computer graphic is associated (1040) with the foreground plane of the first layout area and the presentation width of the third computer graphic is set to approximately zero;
the fourth computer graphic is associated (1050) with the background plane of the second layout area.

35. The method as claimed in claim 34, characterized in that the computer graphics associated with the first layout area are oriented (1080) toward the second layout area.

36. The method as claimed in one of claims 34 and 35, characterized in that the computer graphics associated with the second layout area are oriented (1080) toward the first layout area.

37. The method as claimed in one of claims 34 to 36, characterized in that the layout data record is produced at least to some extent using an SGML.

38. The method as claimed in claim 37, characterized in that the layout data record is produced at least to some extent using an HTML.

39. The method as claimed in one of claims 34 to 38, characterized in that a fifth and sixth computer graphic are selected (1000), and it also has the following steps:
the fifth computer graphic is associated (1060) with the background plane of the first layout area;
the sixth computer graphic is associated (1070) with the foreground plane of the second layout area and the presentation width of the sixth computer graphic is set to approximately zero.

40. An arrangement for the automated animation of a sequence of computer graphics forming pages of a digital document, having an apparatus as claimed in one of claims 1 to 15 and an apparatus as claimed in one of claims 25 to 33.

41. A computer program product, which is stored on a computer-readable storage medium, having computer-readable program means for carrying out the method as claimed in one of claims 16 to 24 and/or one of claims 34 to 39.

42. A computer program product, which is embodied in a digital carrier wave, having computer-readable program means for carrying out the method as claimed in one of claims 16 to 24 and/or one of claims 34 to 39.

43. A data structure product which is stored on a computer-readable storage medium and/or is embodied in a digital carrier wave, for an apparatus as claimed in one of claims 1 to 15, having a layout data record,
wherein the layout data record contains a first layout area (20, 120) having a background plane (22, 122) and a foreground plane (24, 124) and contains a second layout area (30, 130), which is opposite the first layout area, having a background plane (32, 132) and a foreground plane (34, 134),
and wherein also the layout data record has an associated first, second, third and fourth computer graphic, wherein the first and second computer graphics form the open rectos of a double-sided digital document, and wherein the third and fourth computer graphics form the open rectos of the document after forward page-turning,
and wherein also the first computer graphic is associated with the foreground plane of the first layout area, the second computer graphic is associated with the foreground plane of the second layout area, the third computer graphic is associated with the foreground plane of the first layout area and the third computer graphic has an associated presentation width of approximately zero, and the fourth computer graphic is associated with the background plane of the second layout area.

44. The data structure product as claimed in claim 43, characterized in that
the layout data record has an associated fifth and sixth computer graphic, wherein the fifth and sixth computer graphics form the open rectos of the document after backward page-turning,
wherein also the fifth computer graphic is associated with the background plane of the first layout area, the sixth computer graphic is associated with the foreground plane of the second layout area and the sixth computer graphic has an associated presentation width of approximately zero.
